(19) United States
(12) Patent Application Publication
(10) Pub. No.: US 2021/0259222 A1
(43) Pub. Date: Aug. 26, 2021

(54) Got-u-tube

(71) Applicant: Gary L. Lovett, Benton, KY (US)

(72) Inventor: Gary L. Lovett, Benton, KY (US)

(21) Appl. No.: 17/300,032

(22) Filed: Feb. 16, 2021

Related U.S. Application Data
(60) Provisional application No. 62/995,988, filed on Feb. 21, 2020.

(51) Int. Cl. A01K 69/08

(52) U.S. Cl. CPC A01K 69/08

(57) ABSTRACT

The invasion of Asian carp has already affected all inland waters connected to the Mississippi River, devastating the aquatic ecosystem, negatively impacting the fishing and recreation industries and costing our country hundred of millions of dollars. The purpose of the GOT-U-TUBE is to remove large volumes of Asian carp and prevent the necessity of physically handling each fish, while leaving no negative ecological impact. It works differently from current methods of removal not only in its mechanism of action but also in its scale. The device uses a high-pressure water force to create a vacuum within a large tube, utilizing the species' natural fear and group behavior by providing a man-made escape channel, while moving over 5000 gallons of water per minute from the action of the pump alone.

### BACKGROUND OF THE INVENTION

The GOT-U-TUBE is a device proposed to address the issue of Asian carp, and it pertains to the fields of ecology, hydrostatics, and hydraulics. The invasion of Asian carp in the Mississippi, Illinois and Missouri rivers and connected waterways has caused tremendous havoc for at least a decade, reducing population and size of native fish by competing for space and food, decimating native water plants, mussel and other invertebrate populations, and resulting in both environmental devastation to the ecosystem and a hugely negative economic impact to the fishing and recreation industries. Asian carp reproduce at incredible rates, with some females laying up to one million eggs in their lifetimes. They are also a safety risk to humans, as their fear of being trapped or separated from their schools has led to numerous boater injuries from fish jumping up to ten feet out of the water.

Hundreds of millions of federal and state dollars have been spent to combat the issue of Asian carp in our waterways as well as to prevent their introduction to the Great Lakes where their impact on the 7 billion dollar fishing industry would be far more extensive than the problems they've caused thus far. While multiple methods have been tried, the number of Asian carp and the resulting damage has been steadily on the rise. Failure to reign in this invasive species will have exponentially devastating consequences to come. Current methods consist of catching these fish with gill nets after herding them with boats into bays and then removing them by hand, or trying to shock them and remove them one net-full at a time. Both have limited success for such a monumental problem.

The GOT-U-TUBE removes Asian carp from lakes and streams using their fear of being trapped or separated. Fish by nature want to control their ability to move freely. They will even lay on their side in water too shallow to swim or flop across a road in order to reach safer water. Any time they feel threatened, they will seek escape. This device takes advantage of their natural fear of being trapped and the drive to survive by furnishing them a man-made escape channel.

Native Americans used the same principle on buffalo in what is now referred to as buffalo jumps. They would kill a few buffalo, frightening the herd, and direct them over a cliff using their own fear, killing hundreds without firing additional shots.

My personal and work experiences from age ten through adulthood in working with many different materials in a vast number of capacities prompted the idea for the GOT-U-TUBE. As a boy, I helped my father work on deep well pumps. In our area there were many wells that had very fine sand. This sand would be sucked through the foot valve and settle to the bottom in any storage container. I knew that the right application of this could be used to move small material. As a volunteer fire fighter, we welded a one inch high pressure hose nozzle to a pair of vise grips to move large amounts of water. I've also pumped coal, clay, and salt using water as the force. I've used this same principal to move dry material such as clay, salt, and dry cement, but we used air instead of water as the force. All of these particles were fairly small and lightweight and had no movement of their own, but they were all able to be moved by a high pressure force as long as the medium being used by that force totally surrounded the material being moved.

In designing this system, I had to take advantage of the Asian carps' willingness to escape and to accommodate their larger size, while preventing their escape with nets. By using the flowing water we totally encompass the fish, and by herding them, we utilize their fear. The fish believe they've found a way to escape, just as the buffalo did in the buffalo jumps.

### BRIEF SUMMARY OF INVENTION

The GOT-U-TUBE is a device that uses hydraulics and a specifically designed tube to funnel Asian carp as a group for easier removal from bays into which they've been herded. This eliminates the need for the fish to be handled by humans while managing a much bigger fish load at a time. All the water removed with this device is returned within a hundred feet, with no negative ecological impact.

### BRIEF DESCRIPTION OF THE DRAWINGS

FIG. 1 gives a full-length overview of the entire GOT-U-TUBE. FIG. 2 provides a cross-section of the entire device along with precise measurements. FIG. 3 shows a front and side view of the foot. FIG. 4 gives a front and side view of the schedule 80 support near the elbow. FIG. 5 provides a close-up of the center schedule 80 support and middle lifting ring. FIG. 6 shows the lifting ring near the discharge end of the device. Finally, FIG. 7 specifically illustrates a front and side view of the lifting lugs on the foot.

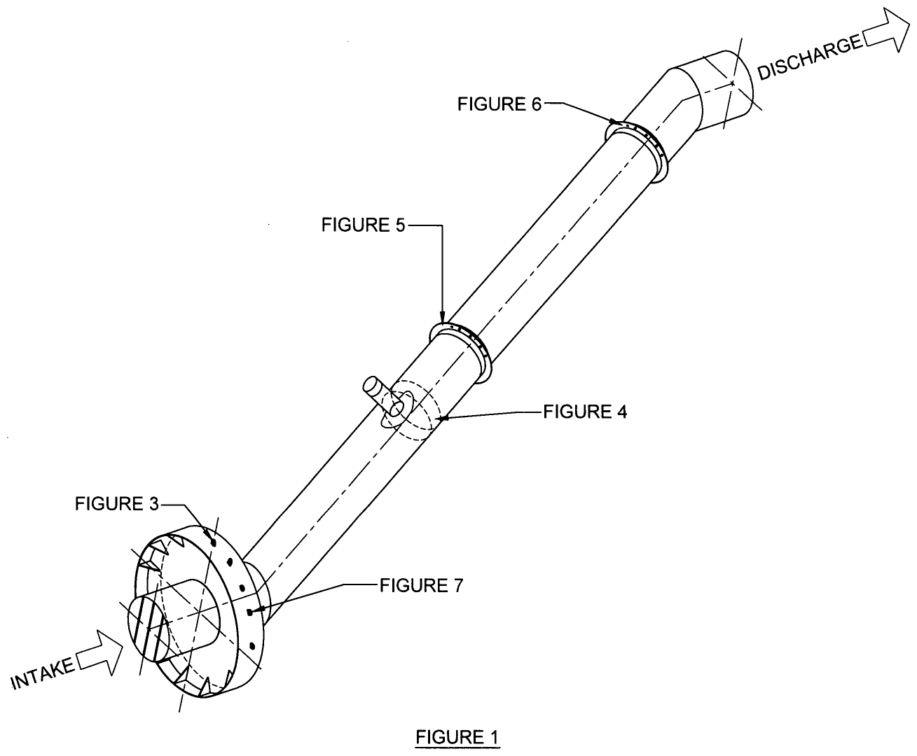

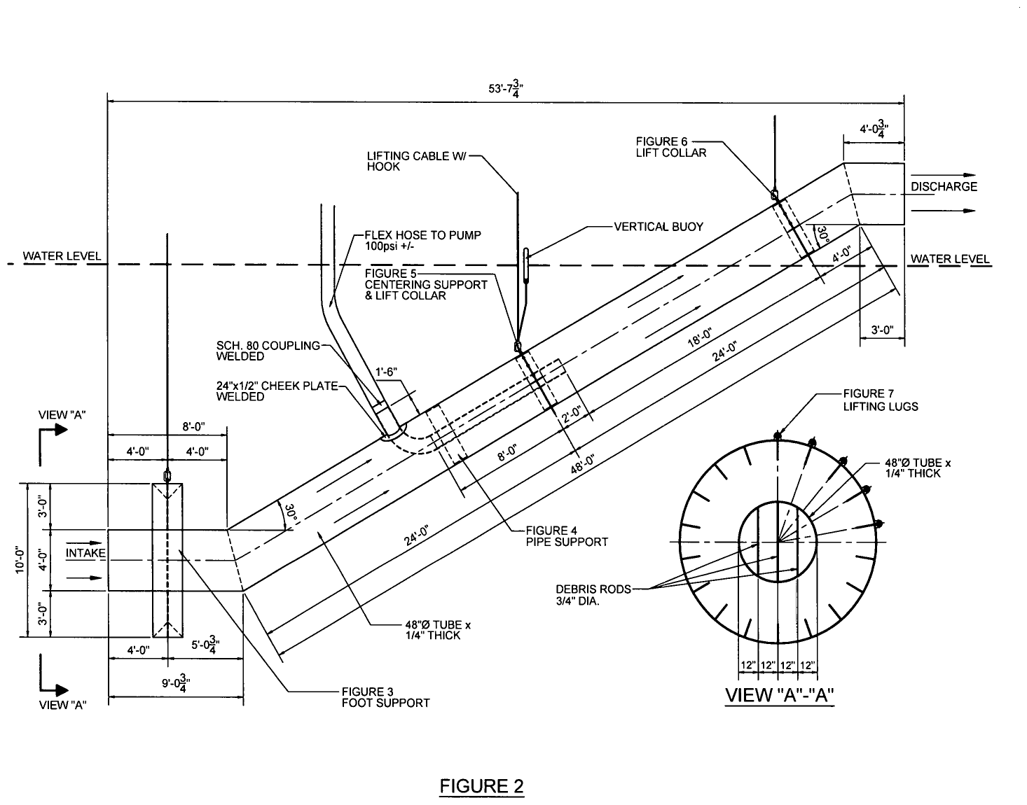

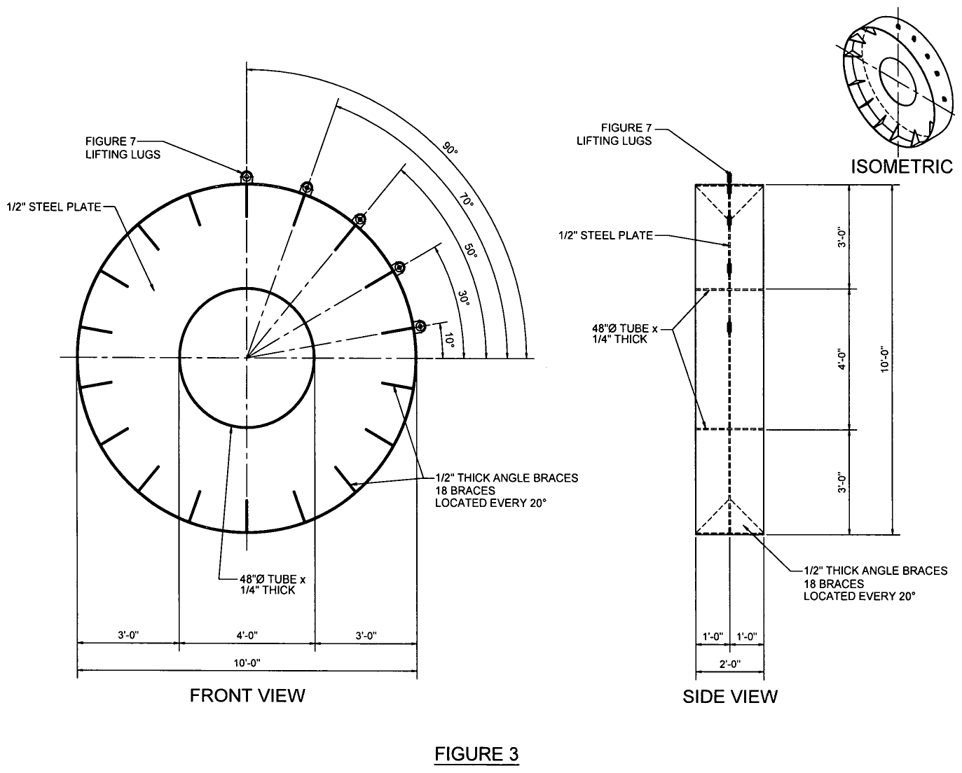

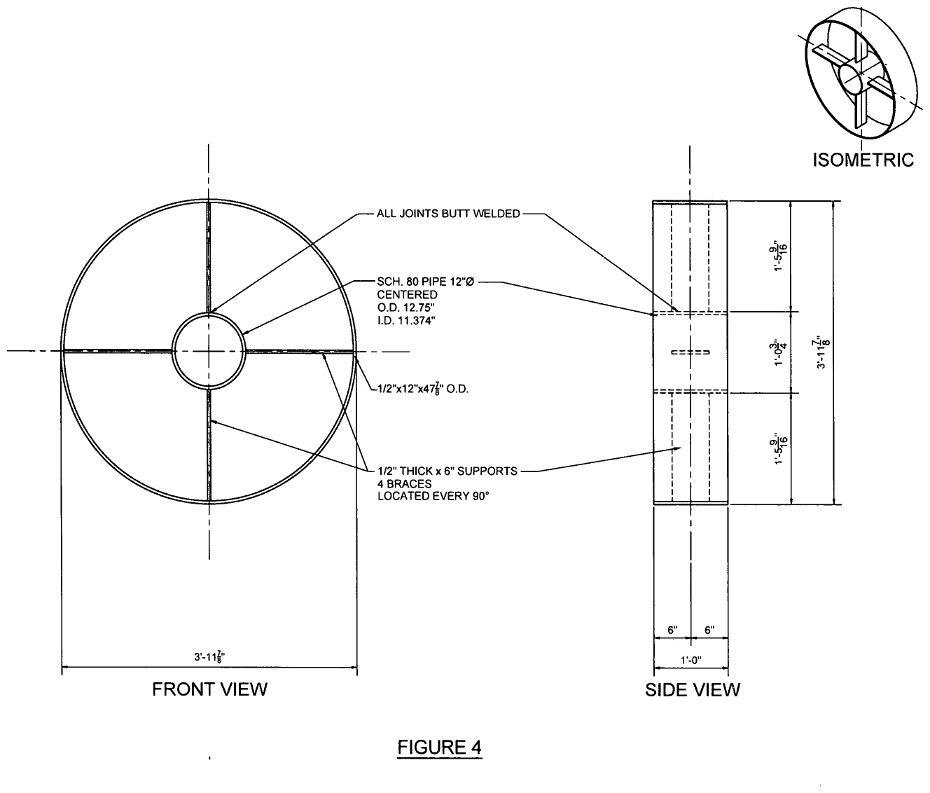

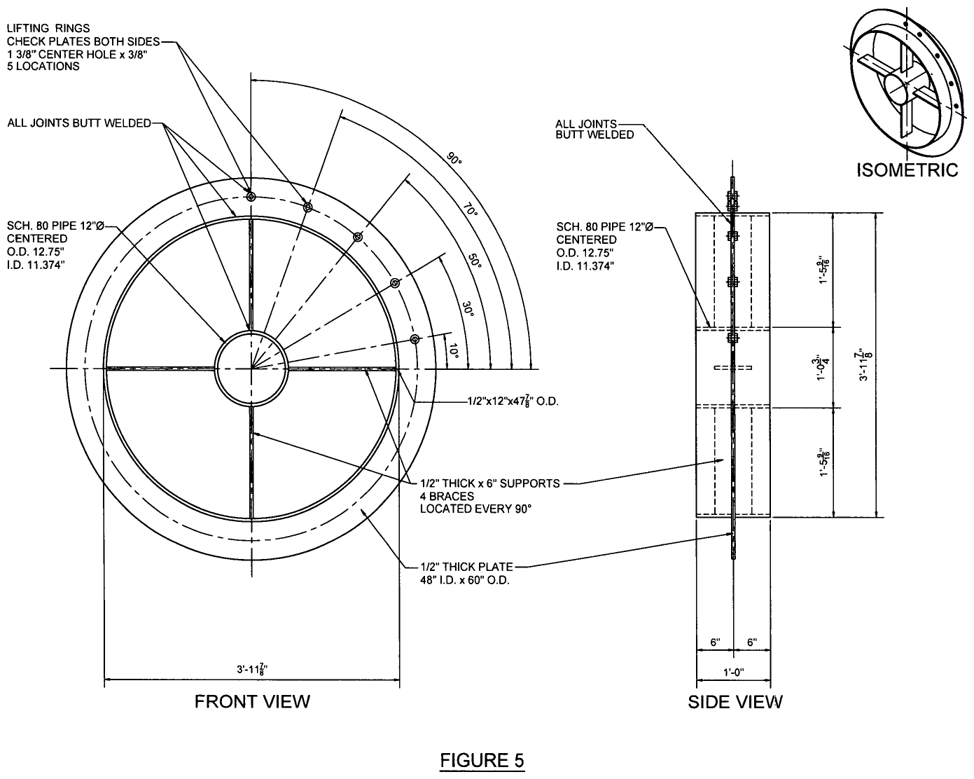

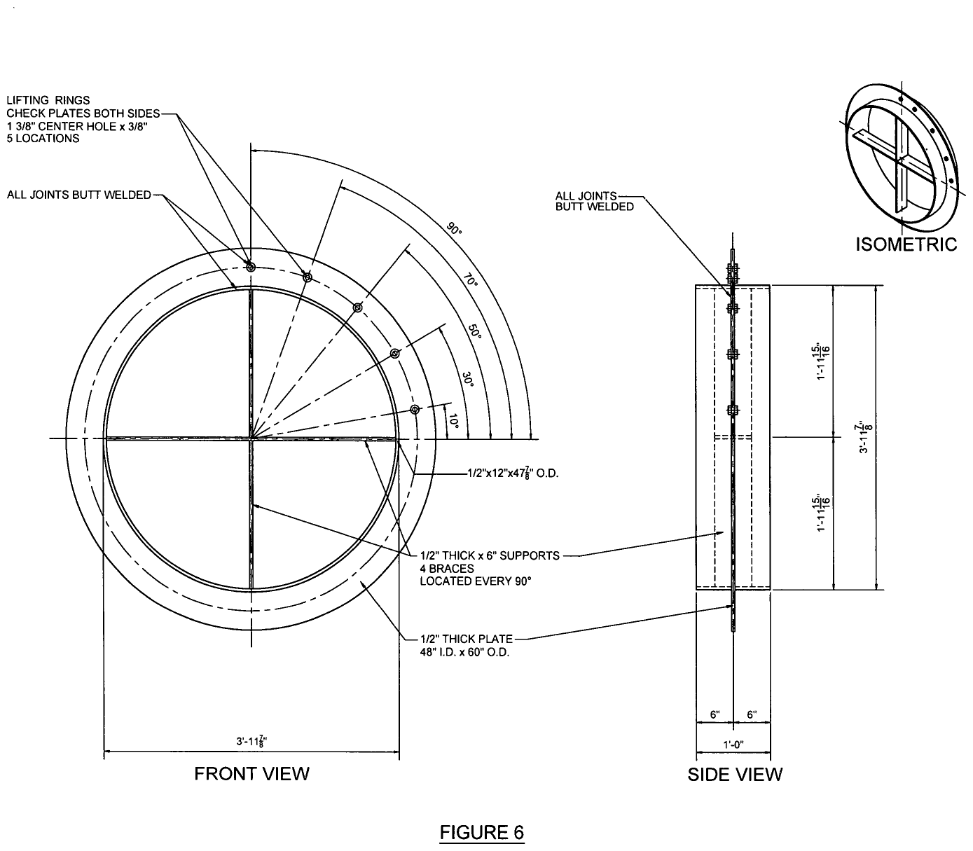

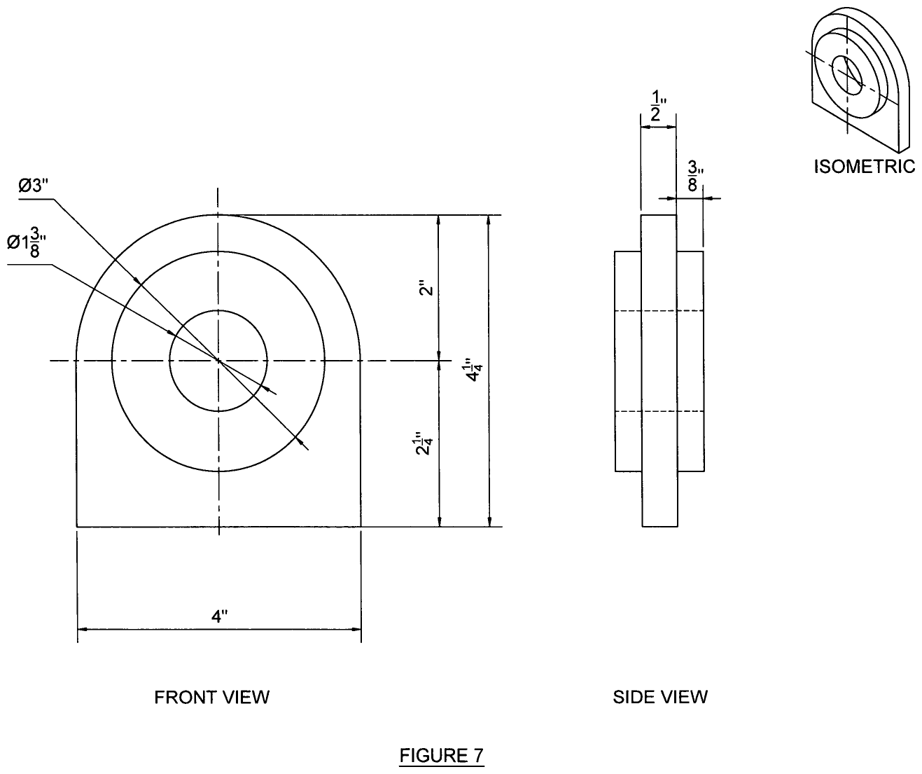

### DETAILED DESCRIPTION OF THE INVENTION

The GOT-U-TUBE design is a pipe nested inside a tube. The tube becomes the escape channel with two opposing bends. The bottom bend allows the unit to set on a foot if needed on the bottom of stream or lake bed. The upper bend enables the water and Asian carp to be ejected perpendicular to the water surface. The pipe allows the high pressure water to come in with as little obstruction as possible and then is centered to ensure equal pressure and volume over the diameter of the tube. A vacuum effect is created by a large high-pressure pump moving water through the pipe. The centering of this pipe allows for equal pressure and volume through the tube.

The GOT-U-TUBE is large to accommodate large numbers of fish, so it is quite heavy. Because of its sheer weight and to accommodate the diesel pump, it has to be used in conjunction with a work barge, along with a 30-ton hydraulic crane.

In this design, the tube is 48 inches in diameter by ¼ inch steel. Both tube ends are open and unobstructed. The length was designed to be used anywhere from just under the surface up to a depth of 25 feet. By using this length and the five different lugs on each of the three lifting rings, it is not necessary to build five different models, but it could be done if desired. All three hook locations are in the top right quadrant, top center, and 20 degrees apart. This allows the GOT-U-TUBE to be closer to the surface as needed. Whatever lug location is chosen for one lifting ring hook needs to correspond with the same lug location on the remaining two lifting ring hooks.

The 12-inch diameter schedule 80 high pressure pipe is supplied by a 300 horsepower diesel pump available to rent or purchase. It is attached to a quick-disconnect threaded coupling welded to the intake side of the pipe above the elbow by a flexible 12-inch line also available to rent.

Near the bottom of the intake, there is a foot which serves two different purposes. First, it serves as a collar to prevent the nets from being sucked into the intake. (The nets referred to here are only used to prevent the herded Asian carp from escaping the bay; they are not part of the device.) Its second function is to raise the intake off the bottom, otherwise it would suck sand, gravel and mud until it reached bedrock.

The water pressure has to be maintained at 100 PSI or above through the pipe. The ratio of tube size to pipe size maintains the vacuum that allows the fish to escape. There are no moving parts inside the tube, only a vertical buoy marking the end of the high pressure and high volume pipe so the operator can maintain its location well below the water surface. It is very important to understand that the pump does not pump fish; it only pumps water. When first lowered into the water, the GOT-U-TUBE has the same water level inside as the water level outside, and this does not change until the pump is started and allowed to reach the desired 100 PSI. The high pressure water and volume, along with its location in the tube creates the vacuum almost instantly. The inside of the tube is basically smooth and length and size can be altered as long as the 4:1 ratio of diameter of tube to diameter of pipe is maintained with a minimum of 100 PSI. The tube can be made of different materials as long as they are smooth and can handle the high pressure, weight and motion.

By the time they get to the discharge end, the fish are airborne. The fish and water do have to be separated, but all water is returned within 100 yards.

I claim:

1. The GOT-U-TUBE will remove Asian carp smaller than one pound and up to at least 100 pounds through this escape channel without having to handle the fish by hand.

2. All the water removed by this method will be returned in less than 100 yards, leaving no negative environmental impact on the lake or stream.

3. Even though this device was designed with the idea of removing live Asian carp, because of its surface capability it can also be used to remove dead fish killed by chemicals or lack of oxygen from the surface.
